(19) United States
(12) Patent Application Publication
(10) Pub. No.: US 2013/0268374 A1
(43) Pub. Date: Oct. 10, 2013

(54) Learning Accounts

(71) Applicants: Kishore Papineni, Carmel, NY (US); Preston McAfee, San Marino, CA (US); John Langford, White Plains, NY (US); Sergei Vassilvitskii, New York, NY (US)

(72) Inventors: Kishore Papineni, Carmel, NY (US); Preston McAfee, San Marino, CA (US); John Langford, White Plains, NY (US); Sergei Vassilvitskii, New York, NY (US)

(73) Assignee: Yahoo! Inc., Sunnyvale, CA (US)

(21) Appl. No.: 13/441,672

(22) Filed: Apr. 6, 2012

(51) Int. Cl. G06Q 30/02

(52) U.S. Cl. 705/14.71

(57) ABSTRACT

Techniques are provided for use in an auction in which selected content items, or advertisements, of content providers, or advertisers, are selected and served, and in which, for an item served in response to a serving opportunity, contingent upon occurrence of a specified user action, an associated provider's account is charged a first sum and an associated publisher's account is credited a second sum. Performance of particular content items may be explored, such as ones for which little or no historical performance information may be available. Content item selection may be based at least in part on an objective of acquiring learning information that can be used in prediction of future performance of the content item. The associated provider's account may be charged a sum that reflects a learning value component, but the associated publisher's account may be credited a sum that does not reflect a learning value component.

### BACKGROUND

In auctions, such as may be used in online advertising, content items such as advertisements may be selected and served in response to serving opportunities. For example, the advertisements may be selected as winners of individual auctions in which advertisers bid and the winning advertisement is selected for serving in response to an advertising opportunity. Advertisements may be selected, for example, based on factors including advertiser bid as well as other parameters, such as one or more predicted performance parameters associated with the advertisement, such as predicted click through rate, or CTR. Machine learning may be used in the selection process, utilizing historical advertisement performance information as input.

Some advertisements, however, at a particular time, may have been rarely or not yet ever selected for serving, and as a result, have very little or no pertinent historical performance information, leading to no or a very low predicted CTR, and further leading to a small or zero chance of selection for future serving opportunities. Given a sufficient chance, however, some such advertisements might actually perform well, which could lead to significant or greater predicted CTR, selection for later serving opportunities, etc. This, in turn, can benefit overall auction ecosystem and marketplace efficiency or optimization, which is good for various parties, such as advertisers, publishers, one or more auction or marketplace facilitators, etc. However, selection of such advertisements, without sufficient historical performance information and sufficient predicted CTR (or other performance parameters), can lead to inequities or unfairness for certain parties, such as in situations in which advertiser payment and publisher credit is given contingent upon some user action, such as a click through.

### SUMMARY

Some embodiments of the invention provide systems and methods for use in an auction in which selected content items, or advertisements, of content providers, or advertisers, are selected and served, and in which, for an item served in response to a serving opportunity, contingent upon occurrence of a specified user action, an associated provider's account is charged a first sum and an associated publisher's account is credited a second sum. Performance of particular content items may be explored, such as ones for which little or no historical performance information may be available. Content item selection may be based at least in part on an objective of acquiring learning information that can be used in prediction of future performance of the content item. The associated provider's account may be charged a sum that reflects a learning value component, but the associated publisher's account may be credited a sum that does not reflect a learning value component.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

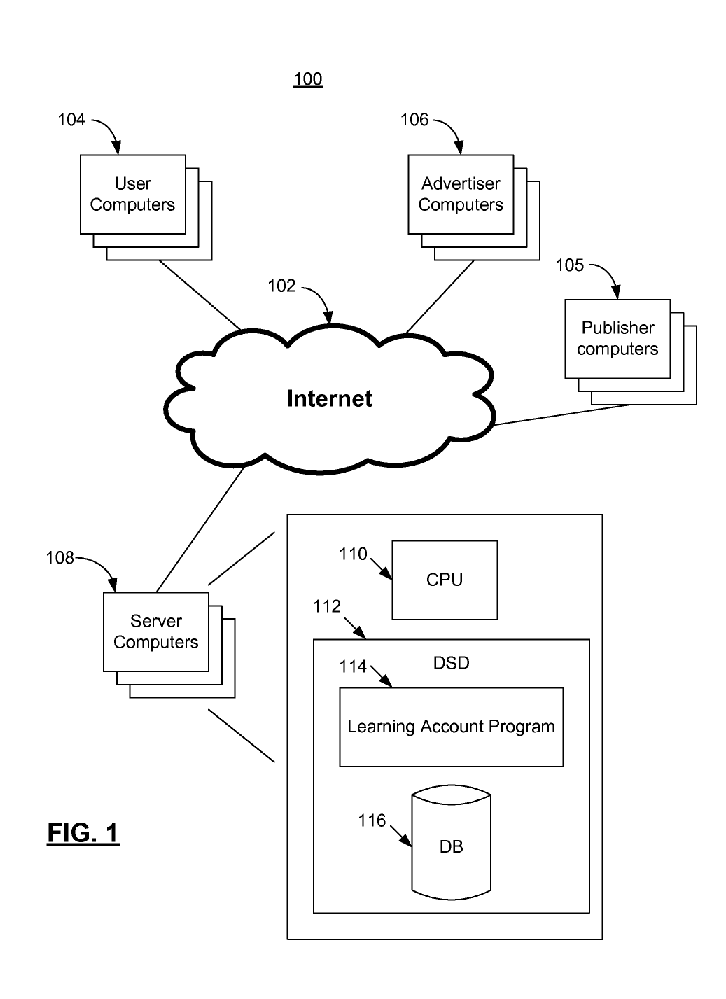

FIG. 1 is a distributed computer system 100 according to one embodiment of the invention. The system 100 includes user computers 104, advertiser computers 106, publisher computers 105 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, smart phone, PDAs, tablets, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, coupon-related advertisements, group-related advertisements, social networking-related advertisements, etc.

As depicted, each of the server computers 108 includes one or more CPUs 110 and a data storage device 112. The data storage device 112 includes a database 116 and Learning Account Program 114.

The Program 114 is intended to broadly include all programming, applications, algorithms, software, engines, modules, functions, and other tools necessary to implement or facilitate methods and systems according to embodiments of the invention. The elements of the Program 114 may exist on a single server computer or be distributed among multiple computers or devices.

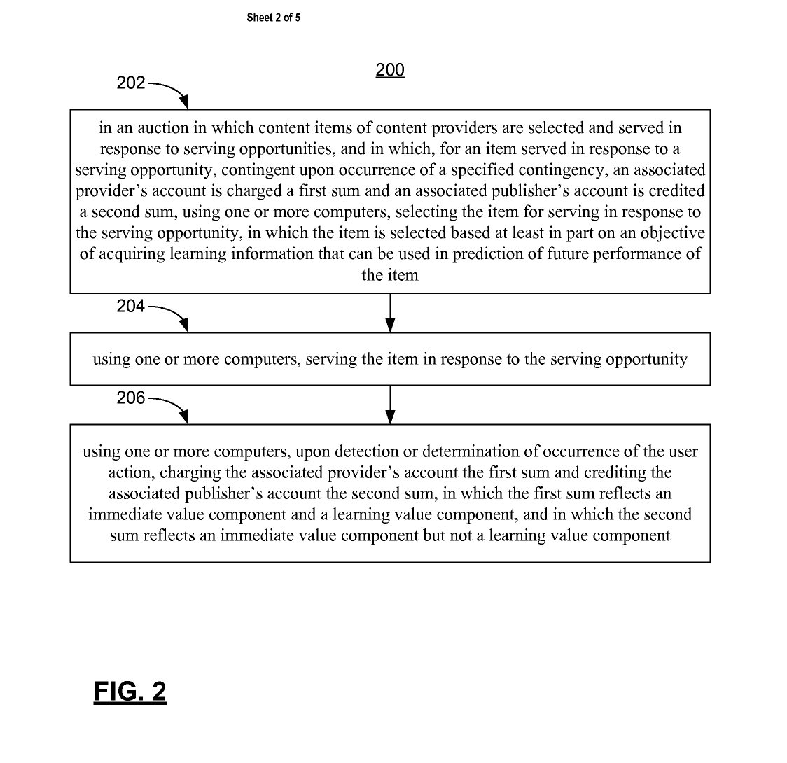

FIG. 2 is a flow diagram illustrating a method 200 according to one embodiment of the invention.

Step 202 includes, in an auction in which content items of content providers are selected and served in response to serving opportunities, and in which, for an item served in response to a serving opportunity, contingent upon occurrence of a specified contingency, an associated provider's account is charged a first sum and an associated publisher's account is credited a second sum, using one or more computers, selecting the item for serving in response to the serving opportunity, in which the item is selected based at least in part on an objective of acquiring learning information that can be used in prediction of future performance of the item.

Step 204 includes, using one or more computers, serving the item in response to the serving opportunity.

Step 206 includes, using one or more computers, upon detection or determination of occurrence of the contingency, charging the associated provider's account the first sum and crediting the associated publisher's account the second sum, in which the first sum reflects an immediate value component and a learning value component, and in which the second sum reflects an immediate value component but not a learning value component.

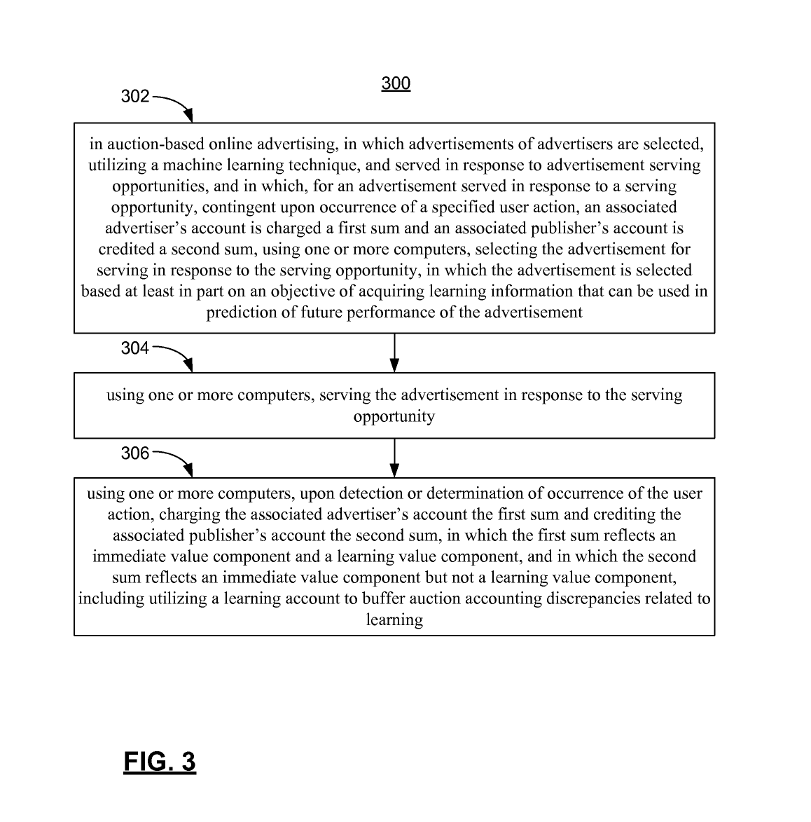

FIG. 3 is a flow diagram illustrating a method 300 according to one embodiment of the invention.

Step 302 includes, in auction-based online advertising, in which advertisements of advertisers are selected, utilizing a machine learning technique, and served in response to advertisement serving opportunities, and in which, for an advertisement served in response to a serving opportunity, contingent upon occurrence of a specified user action, an associated advertiser's account is charged a first sum and an associated publisher's account is credited a second sum, using one or more computers, selecting the advertisement for serving in response to the serving opportunity, in which the advertisement is selected based at least in part on an objective of acquiring learning information that can be used in prediction of future performance of the advertisement.

Step 304 includes, using one or more computers, serving the advertisement in response to the serving opportunity.

Step 306 includes, using one or more computers, upon detection or determination of occurrence of the user action, charging the associated advertiser's account the first sum and crediting the associated publisher's account the second sum, in which the first sum reflects an immediate value component and a learning value component, and in which the second sum reflects an immediate value component but not a learning value component, including utilizing a learning account to buffer auction accounting discrepancies related to learning.

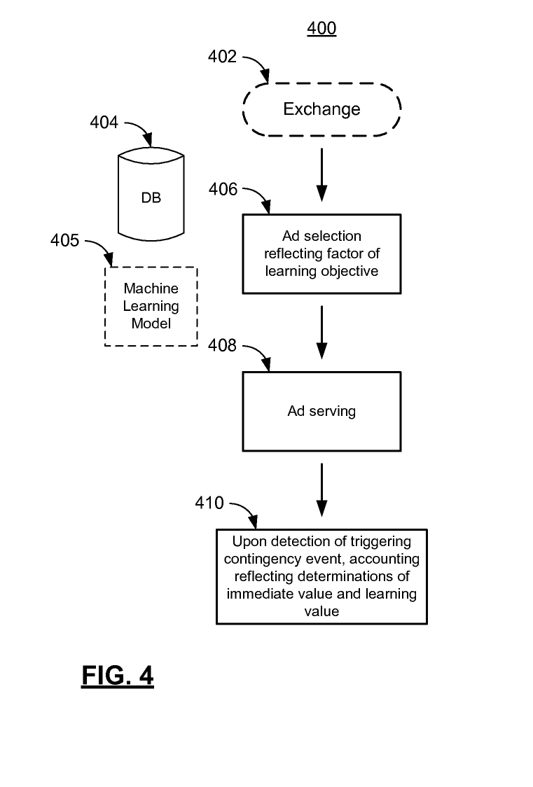

FIG. 4 is a block diagram 400 illustrating one embodiment of the invention. An exchange 402 is depicted, such as a content item or advertising exchange. Block 406 represents advertisement selection reflecting, as a factor (not necessarily an explicit factor), an objective of acquiring learning information regarding the selected advertisement, which may include performance information that can be used in future performance prediction. Various data from one or more databases 404 may be utilized in the selection, and one or more machine learning models 405 may be utilized.

Block 408 represents serving of the selected advertisement in response to the associated serving opportunity.

Block 410 represents, upon detection of a triggering contingency event, accounting reflecting determinations of immediate value and learning value.

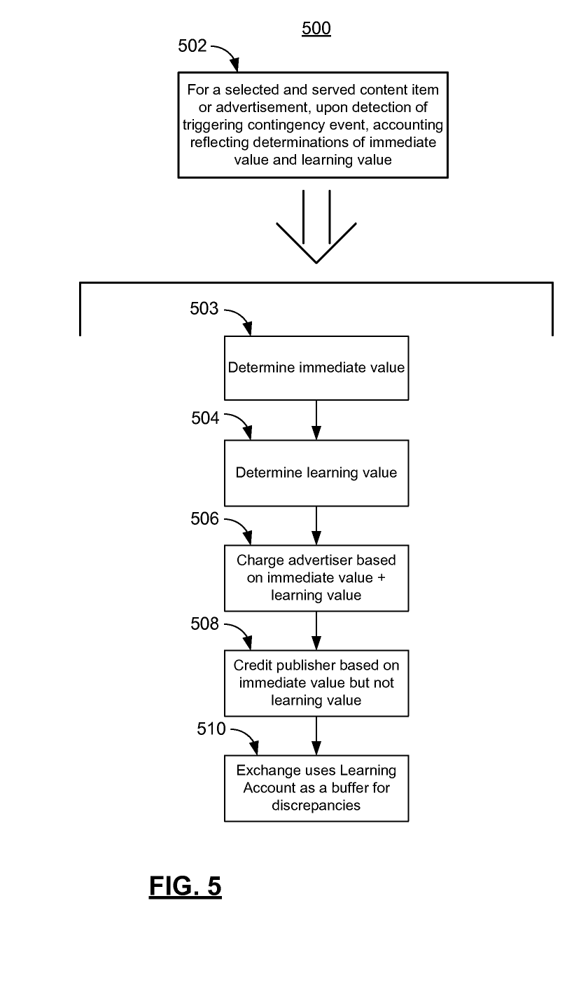

FIG. 5 is a block diagram 500 illustrating one embodiment of the invention. Block 502 represents, for a selected and served content item or advertisement, upon detection of a triggering contingency event, accounting reflecting determinations of immediate value and learning value.

Blocks 504-510 represent, according to one embodiment, various elements of block 502. Blocks 503 and 504 include determinations of an immediate value and a learning value, such as values associated with a detected triggering contingency event or user action.

Block 506 represents charging an advertiser based on the immediate value and the learning value, whereas block 508 represents crediting a published based on the immediate value but not the learning value.

Block 510 represents utilization by the exchange of a Learning Account as a buffer for discrepancies.

Some embodiments of the invention provide incentive-compatible mechanisms for auctions involving contingent payments and machine learning.

Some auctions involve payments that are contingent upon a future event. Many display advertising auctions provide a good example of such auctions. Display advertising exchanges are a big part of the huge display advertising market. These exchanges may run online auctions in which advertisers and publishers participate to buy and sell advertising opportunities (a.k.a. impressions), often one impression at a time. When a user visits a Web page, the website or publisher has an opportunity to show advertisements on that user's page view. The publisher puts up one such opportunity for sale in the auction. Advertisers enter their bids. The auction mechanism or the exchange chooses a winner according to a published auction rule. The winning advertiser's advertisement is then displayed on the page the user is visiting. However, the user may or may not see (or click on) the ad. Different payment methods have arisen in this context: some advertisers (or their agents) pay for the right to display their ad, regardless of user's interaction with the ad. Some advertisers will pay only upon the user clicking on the ad. Some will pay only if the user clicks on the ad, arrives at the advertiser's website via the link in the ad, and performs an action on the advertiser's website (such as buying a product or registering for a newsletter). These payment methods (also known as pricing types) are called CPM (cost per mille impressions), CPC (cost per click), CPA (cost per action) respectively. The (contingent) payment from the advertiser will be passed to the publisher. The exchange makes money in transaction fees. Some embodiments of the invention include concern with how to choose the winner in auctions where contingent payment is involved and there is value in learning the contingency probabilities. Whereas display advertisement auctions are an important example application of the invention, the method described in the invention applies to other auctions that share similar characteristics.

An advertising auction may have many pricing types competing. Thus, the exchange may need to compare the certain CPM offer of an advertiser with uncertain CPC and CPA offers from others. For simplicity, CPC offers are discussed, which may be similar in many relevant ways to CPA offers. An exchange may calculate the expected payment by multiplying the payment-per-click with the probability of the click. This expected payment is called eCPM (for “expected CPM”) and is thus a common currency for comparing all pricing types. Thus, probability of click may be an important part of conducting auctions with mixed pricing types. However, probability of click is not a given or known quantity. Further, it depends on the context. For example, ads for sports cars may have a higher click-through rate (CTR) on a car Web site than on food Web site, and surfing gear ads may have a higher CTR when shown to Californians than to Alabamians. Herein, CTR is used as a shorthand for click probability, although CTR is an empirical quantity and click probability is an abstraction. CTR may be influenced by many factors such as features of the Web page, features of the advertisement and the advertiser, demographic characteristics of the viewer such as age, gender, ethnicity and so on. Thus, estimating CTR may be a difficult problem. Data-driven machine learning methods are commonly used to estimate CTR, and these estimates have a degree of uncertainty (or confidence) associated with them. There is generally more uncertainty about the CTR of a new advertisement, for example, relative to an advertisement that was shown millions of times to similar users on similar Web pages.

A typical auction rule is to select the offer that has the highest eCPM among all participating (eligible) offers. Misestimate of CTR can lead to selecting the wrong offer. For example, suppose there are only two advertisements participating in an auction—one CPM advertisement paying $0.1 and one CPC advertisement paying $1 per click. If the true (but unknown) click probability is 0.09 but the estimated CTR is 0.11, the auction rule may select the CPC advertisement that only pays $0.09 on average. The publisher would have been better off with the CPM advertisement. On the other hand, if the true click probability is 0.2, but estimated to be 0.09, the auction rule selects the CPM advertisement whereas the publisher would be better off with the CPC advertisement on average. Maximum-eCPM auction rule tends to select advertisements whose CTR is overestimated. Thus, publishers tend to display more CPC (risky) advertisements than they should. As such, at least from the publisher's perspective, the exchange may ideally have accurate low-variance estimates of CTR for CPC advertisements.

Machine learning of CTR generally benefits from seeing more examples—CTR estimates for an advertisement may get more accurate with more impressions of that advertisement. However, to get an impression, at the outset, a CPC advertisement may need to either have a high bid or a high CTR, so that its eCPM is high. This can starve deserving advertisements of the exposure they need. Fore example, consider a simplistic example of a CPC advertisement with true click probability of 0.1 that has (somehow) received 10 impressions so far. Suppose that none of these impressions resulted in a click. A naive estimate of CTR is 0, which renders its eCPM zero. This advertisement should generally ideally win against other CPC advertisements with the same bid but with CTRs below 0.1, but will not. Thus we have a classic dilemma: should the exchange choose what is currently known to be the best or should it explore to discover the true hidden gems? Machine learning theory offers many strategies to trade off exploration with ‘exploitation’ (choosing the best known). These strategies may involve trying out the underdogs now and then. Let us assume that same set of advertisements participate repeatedly in auctions for a spot on the same Web page (with similar user characteristics). Upon trying the underdogs every so often, the exchange will eventually estimate the CTRs accurately and will pick the best advertisement almost always. A myopic strategy that does not explore can incur severe loss of revenue for the publisher in hindsight. Thus exploration can induce future value that is beyond the instantaneous value, or learning or future value.

A goal of machine learning can be to generalize from specific examples. Rather than “memorizing” that advertisement A has CTR of 0.1 on Web page P, machine learning may try to generalize its predictions to new ads and new pages, by considering various features of the past examples: by observing that Ford advertisements get numerous clicks on Car & Driver Web site and Toyota advertisements get numerous clicks on Road & Track Web site, a machine learning model or algorithm might hypothesize that automobile advertisements have high CTRs on automotive enthusiast Web sites. Thus, when a new Nissan advertisement enters the auction, the algorithm might predict comparably high CTRs on these and other similar websites. This means that exploring ads on one publisher can benefit another publisher: value of learning can be viewed as having social component.

While learning has value, exploration can be costly: exploration can involve trying out low-eCPM advertisements (according to current estimate), which can lead to short-term regret (revenue loss relative to the current best ad) to the publisher. Note that a CPC advertiser whose advertisements are being explored may not bear any risk, since she only pays for clicks. That is, CPC advertisers may get a free ride in exploration, which may be unfair to the publishers as a whole. Further, exploring certain type of advertisements on one Web site (for example, sportsillustrated.cnn.com) and exploiting that knowledge on other websites (for example, sports.yahoo.com) may not please the first website, at least in the short run. As such, a publisher may want to block exploration on its sites even as exploration eventually benefits all publishers. If a large number of publishers block exploration, then the exchange may not be able to run new advertisements and will suffer severely. Even if a publisher does not block exploration explicitly, it is not clear that a publisher should be asked to bear the cost of exploration for the sake of, for example, group or social benefit. Thus, imposing the social cost on a single publisher who happens to be available may be considered to violate the principle that the parties receiving the benefits should pay for the cost proportionately.

Some embodiments of the invention, for example, help solve or solve problems of externalities induced by machine learning, such as by what can be viewed as decoupling, relative to coupling without use of an embodiment of the invention, the payments made by the buyers and the payments made to the sellers. In some embodiments, in order to accommodate or account for the payments made and revenue collected being different, the exchange maintains a Learning Account, that may, for example, buffer the difference. In some embodiments, it is then queried whether such a Learning runs a deficit (loses money) or not. In some embodiments, generally, fit does not run a deficit, then the exchange can implement the solution without external subsidies. However, there may exist principled assignment of value of learning under which the payment systems described do not need subsidy.

Some embodiments use the concept of total value, such as of a buyer's offer. In some embodiments, the total value is the sum of the instantaneous or immediate value and the future value of learning. In the following, instantaneous value is denoted by r and future value by v. A CPM advertisement generally has no future value of learning and therefore its total value is its instantaneous value. It also generally has no contingency in payment, thus its instantaneous value is simply the (fixed) payment per impression. Suppose that a CPC advertiser bids bi for an impression of advertisement i, which has ci probability of a click. The instantaneous value (to the publisher) is ri=eCPMi=cibi. However, running the advertisement has a future social value of learning vi. Thus its total value is ti=cibi+vi. In some embodiments, it is considered that there is an instantaneous value, such as to the seller, and a future value, such as to the system, that may applicable to advertising systems as well as beyond the world of advertisements. For example, in some embodiments, it may be applicable whenever there are contingent payments and machine learning used in learning the contingency probabilities.

In an auctions, a rule may be to select the offer with the highest total value. In some embodiments, suppose that the offers are renumbered such that t₁ is the highest total value, t₂ is the second highest, and so on. Note that t₁=c₁b₁+v₁. The winner could have lowered the bid b₁ to b such that c₁b+v₁=r₂+v₂ and still won the auction. Lowering the bid further will make advertisement 2 win the auction. Therefore, an incentive-compatible average payment from the winner can equal r₂+v₂−v₁=p. There is no incentive for the winner to pay more. Since the payment by the winner is independent of the actual bid (conditioned on winning), bidders generally bid their value as the auction mechanism chooses the system-efficient offer. It may not be desired to impose the social cost of learning on the seller, so the mechanism pays the seller as if there were no future value of learning. In the absence of value of learning, seller gets what the winner pays and the winner pays the second highest instantaneous value. Thus, on average, the mechanism collects p from the winner and pays the second-highest r to the seller (dividing these quantities by c₁ will give the contingent revenue and payment). Note that the second highest r is not necessarily the same as r of the advertisement with the second highest total value. There are indeed two different rankings of the offers: one is based on total value (instantaneous, or immediate, value plus learning value, and the other is based on just the instantaneous value.

In some embodiments, for example, consider three offers with instantaneous values of $3, $1, $2 and values of learning $4, $4.5, $0 respectively. The total values will be $7, $5.5, $2. The second offer has the second highest total value, whereas the third offer has the second highest instantaneous value. In this case, first offer wins and pays 1+4.5−4=$1.5 to the exchange. The exchange pays $2 (the second highest r) to the seller. In this example, the exchange must dip into its learning account to make up the difference in revenue and payment. One can make up other examples where the exchange nets a surplus in an auction. A question is whether the exchange runs a deficit or surplus in the long run. In some embodiments, the payment system will have non-negative surplus.

Note that, in some embodiments, the vᵢ calculation for each offer may depend on the specific machine learning algorithm used, as known in the art. Many embodiments of the payment system are possible. For example, one embodiment is based on a popular machine learning exploration-exploitation policy called ‘Upper Confidence Bound’ policy.

In some embodiments, as an example, an auction process may proceed as follows:
1. Seller puts up an item for auction.
2. Buyers enter offers with bids bᵢ
3. Exchange computes total value tᵢ=rᵢ+vᵢ for all offers.
   For non-contingent offers: rᵢ=bᵢ and vᵢ=0.
   For contingent offers: rᵢ=cᵢ bᵢ. Contingency probability cᵢ and value of learning vᵢ are calculated by a machine-learning algorithm.
4. Exchange assigns each offer a rank by t as well as a rank by r. Notation: t₁≧t₂≧t₃ . . . and r₍₁₎≧r₍₂₎≧r₍₃₎ . . . Subscripts with brackets denote ranking by r and subscripts without brackets denote ranking by t.
5. Exchange chooses the offer with the highest total value as the winner.
6. Exchange charges the winner t₂−v₁
7. Exchange pays the seller r₍₂₎
8. Exchange collects a transaction fee from the seller and the winner.

Some embodiments include decoupling of receipts and payments. For example, in some embodiments, receipts from buyers are based on total value whereas payments to the sellers are based on only the immediate value. Some embodiments introduce a separation of receipts from buyers and payments to sellers by the auctioneer where the auctioneer establishes a ‘learning account’ that supports the cost of learning.

Some embodiments introduce a novel auction mechanism that methodically chooses the winner, decides how much the winner must pay, and how much the seller will receive. Furthermore, some embodiments establish a novel auction mechanism is incentive-compatible for buyers so that they will bid their true value for items being sold.

While the invention is described with reference to the above drawings, the drawings are intended to be illustrative, and the invention contemplates other embodiments within the spirit of the invention.

1. In an auction in which content items of content providers are selected and served in response to serving opportunities, and in which, for an item served in response to a serving opportunity, contingent upon occurrence of a specified contingency, an associated provider's account is charged a first sum and an associated publisher's account is credited a second sum, a method comprising:
using one or more computers, selecting the item for serving in response to the serving opportunity, in which the item is selected based at least in part on an objective of acquiring learning information that can be used in prediction of future performance of the item;
using one or more computers, serving the item in response to the serving opportunity; and
using one or more computers, upon detection or determination of occurrence of the contingency, charging the associated provider's account the first sum and crediting the associated publisher's account the second sum, wherein the first sum reflects an immediate value component and a learning value component, and wherein the second sum reflects an immediate value component but not a learning value component.

2. The method of claim 1, comprising detection or determination of occurrence of the contingency, wherein the contingency comprises a specified user action.

3. The method of claim 1, wherein selecting content items comprises selecting online advertisements.

4. The method of claim 1, comprising utilizing a learning account to buffer auction accounting discrepancies related to learning.

5. The method of claim 1, comprising utilizing a learning account to buffer auction accounting discrepancies related to the content item selection, wherein the item is selected based at least in part on the objective of acquiring the learning information, and related to charging the associated provider's account the first sum and crediting the associated publisher's account the second sum, wherein the first sum reflects the immediate value component and the learning value component, and wherein the second sum reflects the immediate value component but not the learning value component.

6. The method of claim 1, wherein the specified user action comprises a click or conversion.

7. The method of claim 1, comprising utilizing a machine learning technique in selection of content items.

8. The method of claim 1, comprising utilizing acquired learning information to explore performance of content items.

9. The method of claim 1, comprising utilizing acquired learning information to explore performance of content items for which little or no historical performance information is otherwise available relative to other content items.

10. The method of claim 1, comprising charging the associated provider's account the first sum and crediting the associated publisher's account the second sum, wherein the first sum reflects a learning value component and the second sum does not, is utilized in fairly spreading the cost of exploration of performance of particular content items among publishers participating in an auction marketplace.

11. In auction-based online advertising, in which advertisements of advertisers are selected, utilizing a machine learning technique, and served in response to advertisement serving opportunities, and in which, for an advertisement served in response to a serving opportunity, contingent upon occurrence of a specified user action, an associated advertiser's account is charged a first sum and an associated publisher's account is credited a second sum, a system comprising:
one or more server computers coupled to a network; and
one or more databases coupled to the one or more server computers;
wherein the one or more server computers are for:
selecting the advertisement for serving in response to the serving opportunity, in which the advertisement is selected based at least in part on an objective of acquiring learning information that can be used in prediction of future performance of the advertisement;
serving the advertisement in response to the serving opportunity; and
upon detection or determination of occurrence of the user action, charging the associated advertiser's account the first sum and crediting the associated publisher's account the second sum, wherein the first sum reflects an immediate value component and a learning value component, and wherein the second sum reflects an immediate value component but not a learning value component.

12. The system of claim 11, wherein selecting content items comprises selecting online advertisements.

13. The system of claim 11, comprising utilizing a learning account to buffer auction accounting discrepancies related to learning.

14. The system of claim 11, comprising utilizing a learning account to buffer auction accounting discrepancies related to the content item selection, wherein the item is selected based at least in part on the objective of acquiring the learning information, and related to charging the associated provider's account the first sum and crediting the associated publisher's account the second sum, wherein the first sum reflects the immediate value component and the learning value component, and wherein the second sum reflects the immediate value component but not the learning value component.

15. The system of claim 11, wherein the specified user action comprises a click or conversion.

16. The system of claim 11, comprising utilizing a machine learning technique in selection of content items.

17. The system of claim 11, comprising utilizing a machine learning model in selection of content items, and wherein acquired learning information is used to enhance performance of the model.

18. The system of claim 11, comprising utilizing acquired learning information to explore performance of content items.

19. The system of claim 11, comprising utilizing acquired learning information to explore performance of content items for which little or no historical performance information is otherwise available relative to other content items.

20. A computer readable medium or media containing instructions for executing a method, in auction-based online advertising, in which advertisements of advertisers are selected, utilizing a machine learning technique, and served in response to advertisement serving opportunities, and in which, for an advertisement served in response to a serving opportunity, contingent upon occurrence of a specified user action, an associated advertiser's account is charged a first sum and an associated publisher's account is credited a second sum, the method comprising:
using one or more computers, selecting the advertisement for serving in response to the serving opportunity, in which the advertisement is selected based at least in part on an objective of acquiring learning information that can be used in prediction of future performance of the advertisement;
using one or more computers, serving the advertisement in response to the serving opportunity; and
using one or more computers, upon detection or determination of occurrence of the user action, charging the associated advertiser's account the first sum and crediting the associated publisher's account the second sum, wherein the first sum reflects an immediate value component and a learning value component, and wherein the second sum reflects an immediate value component but not a learning value component, comprising utilizing a learning account to buffer auction accounting discrepancies related to learning.
